(19) United States
(12) Patent Application Publication
(10) Pub. No.: US 2009/0148043 A1
(43) Pub. Date: Jun. 11, 2009

(54) METHOD FOR EXTRACTING TEXT FROM A COMPOUND DIGITAL IMAGE

(75) Inventors: Boaz Ophir, Haifa (IL); Yaakov Navon, Ein Vered (IL)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/951,532

(22) Filed: Dec. 6, 2007

(51) Int. Cl. G06K 9/34

(52) U.S. Cl. 382/176

(57) ABSTRACT

Text is extracted from a grayscale or color compound digital image. Kernels of text in the compound digital image are found using a stroke operator. The kernels of text are segmented into text blocks based on image space, color space, and intensity space. Each text block is segmented into text and background pixels using active contour analysis. The segmented text blocks are refined by altering parameters in the active contour analysis. Text is extracted from the refined segmented text blocks, and a binary image is created including text extracted from the refined segmented text blocks.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

This invention relates to extraction of text from images, in particular extraction of text from a compound digital image.

The emergence of mobile phones equipped with high resolution cameras, audio recording facilities, memory, and processing capabilities makes them ideally suited for acquiring information in real time. For example, while a person is standing in a bus station, he or she is surrounded with a lot of posters and advertisements. In many cases, the person may like to keep the information of an advertisement, and it is easy to do so by capturing an image of the advertisement with the mobile phone. The complementary parts of the image capture is to automatically extract the textual data from the captured image and to convert it into useful information, such as phone numbers, URLs, names, addresses, events, etc.

There is still difficulty in extracting textual data from images acquired from different kinds of media, whether business cards or posters hanging at a bus station. The acquisition of the images is carried out by unskilled people, under difficult illumination conditions, with poorly calibrated cameras and other noisy conditions. Reaching a reasonable recognition rate with such images is a great challenge in image processing.

While Optical Character Recognition (OCR) technologies exist to translate handwritten or typewritten text images into machine-editable text, most of the current OCR applications decode images that are captured by well-calibrated flat bed scanners.

Current solutions are not generalized to handle many types and text, colored text, text printed on noisy background, light text printed on dark background and others.

### SUMMARY

According to an exemplary embodiment, a method is provided for extracting text from a grayscale or color compound digital image. Kernels of text in the compound digital image are found using a stroke operator. The kernels of text are segmented into text blocks based on image space, color space, and intensity space. Each text block is segmented into text and background pixels using active contour analysis. The segmented text blocks are refined by altering parameters in the active contour analysis. Text is extracted from the refined segmented text blocks, and a binary image is created including text extracted from the refined segmented text blocks.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a compound digital image including text;

FIGS. 2A-2C illustrate various stages of extracting text from a compound digital image including text;

FIG. 3 is a flow diagram depicting a process for extracting text from a compound digital image according to an exemplary embodiment.

The detailed description explains exemplary embodiments, together with advantages and features, by way of example with reference to the drawings.

### DETAILED DESCRIPTION

According to exemplary embodiments, a very robust method for extracting text from compound/complicated images is provided without requiring a priori information about the nature of the images. The text may be located at any position within the image, have different fonts and colors, and partly distorted due to the nature of the acquisition conditions.

According to exemplary embodiments, two powerful tools are provided for extraction and binarization of text: a stroke kernel operator and active countour analysis. By combining a stroke kernel operator with active contour analysis, text can be specifically targeted even in complex color images including, e.g., varying and noisy background, dark text on bright background and vice versa, low quality text, etc.

The term “stroke” refers to the width or thickness of text characters (e.g., of pen/pencil/typewritten strokes). The stroke kernel identifies small areas of the image that are of interest, i.e., contain text. The contour analysis then focuses only on these areas, applying powerful segmentation and binarization only on relevant parts of the image.

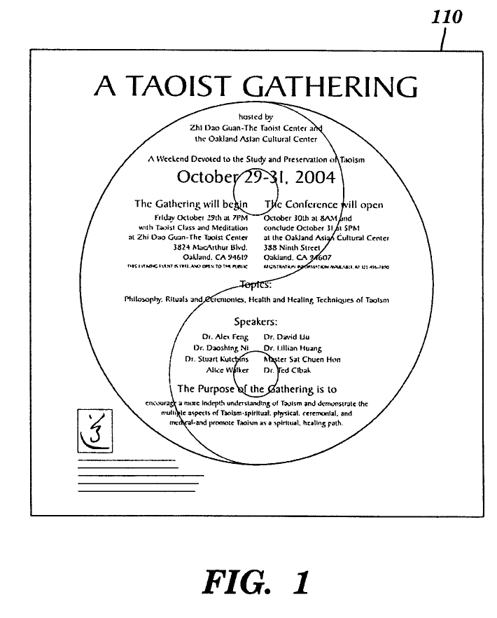

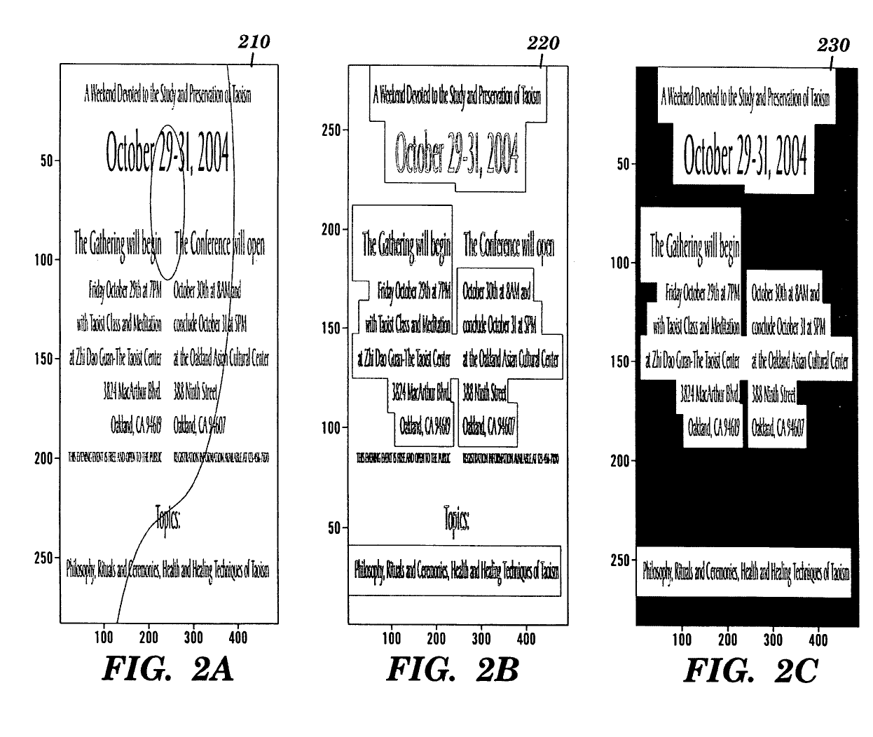

In the following detailed description, the input is a compound digital image in grayscale or in colors, and the output includes a set of binary images ready for OCR processing. An example of an input compound image including text is the image 110 shown in FIG. 1. A smaller version of the image is shown, for comparison purposes, as image 210 in FIG. 2A.

The process for extracting text begins with a stroke operation. The purpose of this operation is to identify pixels that are part of text. Such pixels typically stand out from their immediate surrounding. A stroke operator, described below, identifies such pixels.

Let P(x,y) denote pixel intensity or color vectors at the x and y point coordinates, let w be the dominant stroke width, and let be d be w\sqrt{2}. Based on the above, most “text” pixels in an image can easily be set by applying an operator that emphasizes “strokes” in the image. Checking for contrast along several directions easily reveals stroke pixels. One such operator, which checks the contrast in four directions (horizontal, vertical and two diagonal directions) is given in the following:

[ABS(P(x−w, y)−P(x,y))>t AND ABS(P(x+w, y)−P(x,y))>t] OR

[ABS(P(x, y−w)−P(x,y))>t AND ABS(P(x, y+w)−P(x,y))>t] OR

[ABS(P(x+d, y+d)−P(x,y))>t AND ABS(P(x−d, y−d)−P(x,y))>t] OR

[ABS(P(x−d, y+d)−P(x,y))>t AND ABS(P(x+d, y−d)−P(x,y))>t]

where the positive threshold parameter t is the contrast in a grayscale image, or “color difference” in a color image (for instance, L₁ norm). One can easily verify that the accuracy of the stroke width in this operator is not important, due to the fact that strokes of text are well surrounded with background. The result of applying the stroke operator on an input image is a stroke kernel mask covering the pixels located on strokes of width up to d and in contrast with the close surrounding pixels.

The next step in the process for text extraction is connected component layout analysis of the text mask. The goal of this stage is to merge the stroke mask components into blocks that potentially contain text. For this purpose, the mask is first cleaned from artifacts that are not deemed to be caused by text (using heuristics on reasonable text size). The remaining mask elements are then merged to create blocks.

As part of cleaning, very small elements in the image that are deemed too small to be characters are removed, by median/morphological operators. Very large elements that are deemed too big to be text are removed by area opening. These, and other, heuristics can be applied in the various processing stages to prune the results from unlikely candidates.

After cleaning, elements in the image are connected by morphological closing with horizontal structuring element and close holes, and connected component analysis is applied on the mask. Potential text masks are created by taking bounding box of each connected component. Thus, each mask covers a small region of the image where the stroke operator had many hits.

After layout analysis, active contour based text extraction is performed. This stage segments each text block into text and background pixels. Text is segmented from the background using active contours. An example of active contour analysis is the Chan Vese model, described in detail in T. Chan and L. Vese, “Active contours without edges”, IEEE Trans. Image Processing, vol. 10, no. 2, pp. 266-277, February 2001).

In this model, starting from an initial curve, a curve evolves so as to segment an image into two parts so that the pixel variance in each part is minimal, while keeping the length of the curve to a minimum.

Formally, a curve C is evolved as to minimize the cost function F:

$$F ( {c}_{1} , {c}_{2} , C ) = μ \cdot Length ( C ) + {λ}_{1} \cdot {\int }_{inside ( C )} {\vert {u}_{0} ( x , y ) - {c}_{1} \vert}^{2} d x d y + {λ}_{2} \cdot {\int }_{outside ( C )} {\vert {u}_{0} ( x , y ) - {c}_{2} \vert}^{2} d x d y$$

where u₀ is the original image, and c₁ (c₂) is the average pixel value inside (outside) the curve, μ<0, and λ1, λ2>0 are fixed parameters.

Starting from an initial curve, the curve evolves at small time steps so as to minimize the function F, until the solution is stationary (or for a fixed number of iterations). Implementation may be done using a level set formulation of the model. This operation is applied to each color image block (extracted in the layout analysis stage) separately.

FIGS. 2B and 2C illustrate examples of images to which active contour analysis has been applied. In FIG. 2B, image 220 shows the text contours. In FIG. 2C, image 230 shows the text contours with the text color and background color applied.

Following the active contour segmentation, the task remains to determine which of the two segments (extracted for each block in the previous stage) contains text. The active contour operation separates the image into two segments with average values c₁ and c₂. One of these colors belongs to text and the other to the background, and a determination is made as to which color corresponds to text, and which color corresponds to background. The background color is estimated by taking the median pixel value in the band immediately surrounding the box on which the active contours was applied. The segment with average color farthest from the background color is classified as text. Thus, both dark text on light background and light text on a dark background may be correctly identified.

After the active contour segmentation stage (and the background/text classification), a thinning/thickening decision can be made for the text. Determining if the text is too thick/thin can be done using simple heuristics on the connected components. For example, if the aspect ratio of the connected components leans heavily to the horizontal, this probably means that letters have stuck together because they are thick. If many components are very small then probably the letters have broken apart because they are thin. Also, the average (or median) length of black runs may be compared to white runs to provide an indication as to whether the text is thick or thin. After a determination is made whether the text is too thin or too thick, the text may be made thicker or thinner, as appropriate.

The segmentation may then be refined by an additional active contour stage in which the relative sizes of the parameters λ1 and λ2 is changed. For example, consider the case that in previous stages it was determined that the segment with color c1 is the text, and c2 is the background. Increasing λ1 (relatively to λ2) will give higher penalty to pixel variance in the text segment. This will cause pixels on the borders of the group (with values in between c1 and c2) to be more likely to migrate to the background segment, thus thinning the text. And vice versa, increasing λ2 (relatively to λ1) will cause background pixels immediately surrounding the text to migrate into the text segment, thus thickening the text.

The text segment is binarized to a ‘0’ (black) value, and the background is binarized to a ‘1’ (white) value. Segments in which the distance between c₁ and c₂ is smaller than a certain threshold (for instance, 0.5·t, where t is the threshold used in the stroke operator) are classified as not containing text.

Prior to running an OCR engine, some more processing may need to be done. For this purpose, binary images containing the text blocks in their original positions may be created.

According to an exemplary embodiment, a series of binary images may be constructed by aggregating binary text segments in the same region. Segments that are both close in location and text color (prior to binarization) are combined to create binary text images. Each segment is positioned according to its location in the original image. Thus, sentences that may have been broken in previous stages, are recreated. Pixels that are not in any text segment may be designated as having a ‘1’ (white) value. These images are now ready for further pre-OCR processing, such as layout analysis and de-skewing, before being passed on to an OCR engine.

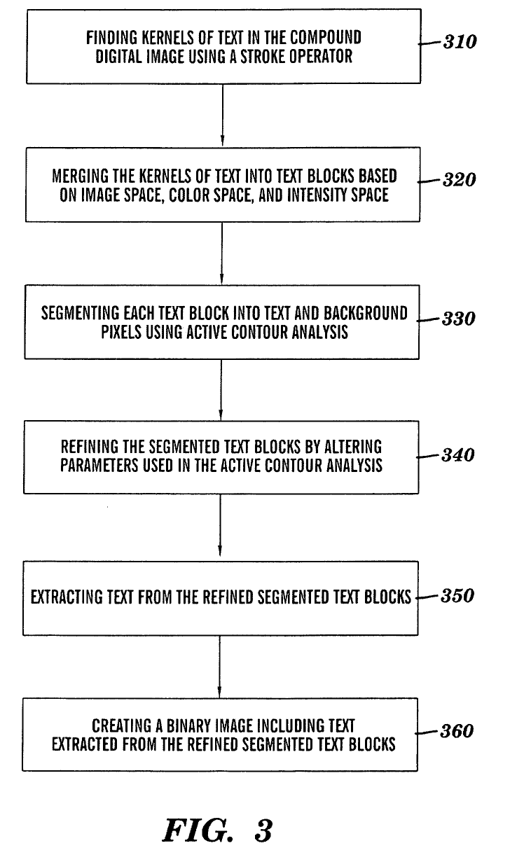

FIG. 3 is a flow diagram depicting a method for extracting text from a compound digital image according to an exemplary embodiment. As shown in FIG. 3, the process begins at step 310 at which kernels of text are found in the compound digital image using a stroke operator. At step 320, the kernels of text are merged into text blocks based on image space, color space, and intensity space. At step 330, each text block is segmented into text and background pixels using active contour analysis. At step 340, the segmented text blocks are refined by altering parameters in the active contour analysis. At step 350, text is extracted from the refined segmented text blocks. At step 360, a binary image including text is created. The binary image may be used for OCR.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments have been described, it will be understood that those skilled in the art, both now and in the future, may make various improvements and enhancements which fall within the scope of the claims which follow. These claims should be construed to maintain the proper protection for the invention first described.

What is claimed is:

1. A method for extracting text from a grayscale or color compound digital image, comprising:
finding kernels of text in the compound digital image using a stroke operator;
merging the kernels of text into text blocks based on image space, color space, and intensity space;
segmenting each text block into text and background pixels using active contour analysis;
refining the segmented text blocks by altering parameters used in the active contour analysis;
extracting text from the refined segmented text blocks; and
creating a binary image including text extracted from the refined segmented text blocks.

2. The method of claim 1, wherein the step of finding kernels of text produces stroke masks, and the step of merging the text kernels into text blocks includes merging the stroke masks into blocks that potentially contain text.

3. The method of claim 1, further comprising determining whether the segmented text blocks contain text that is too thick or too thin and altering the thickness of the text if the text is determined to be too thick or too thin.
